(19) United States
(12) Patent Application Publication
(10) Pub. No.: US 2005/0169442 A1
(43) Pub. Date: Aug. 4, 2005

(54) Exchange and communication method

(75) Inventor: Kazuo Nakano, Niiza-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 10/968,304

(22) Filed: Oct. 20, 2004

(30) Foreign Application Priority Data
Jan. 30, 2004 (JP) P2004-024646

(51) Int. Cl. H04M 1/64; H04M 11/00

(52) U.S. Cl. 379/88.16; 379/67.1

(57) ABSTRACT

An exchange controls a display section of a receiving side telephone in accordance with recording of an originating side voice, and controls an output of the originating side voice from a voice output section in accordance with an input to an input section of the receiving side telephone. A recipient can check with the display section that recording of the originating side voice is in progress, and make the originating side voice being recorded outputted, by operating the input section. Since it is possible to output the voice after checking a situation around the receiving side telephone, a risk that the originating side voice is improperly heard by someone else is reduced.

### CROSS REFERENCE TO THE INVENTION

This application is based upon and claims the benefit of priority from the prior Japanese Patent Application No. 2004-024646, filed on Jan. 30, 2004; the entire contents of which are incorporated herein by reference.

### BACKGROUND OF THE INVENTION

1. Field of the invention

The present invention relates to an exchange and a communication method having a recording function to record a voice from an originating side telephone.

2. Description of the Related Art

A telephone exchange having a recording function to record a message when a call destination is unattended and to enable listening to the recorded message later is used.

An art is disclosed in which a voice being recorded is monitored with a speaker of an extension telephone and hooking off a handset enables a call with a party whose voice is being recorded (see Japanese Patent Laid-open Application No. Hei 09-116629).

### SUMMARY OF THE INVENTION

In the above-described prior art, when someone else is near the extension telephone it is possible that the voice being recorded is heard via the speaker. In this case if the handset is hooked off in order for stopping a voice output from the speaker, the call with a party whose voice is being recorded is to start.

In view of the above, it is an object of the present invention to provide an exchange and a communication method capable of preventing the voice being recorded from being heard by someone else.

An exchange related to an embodiment of the present invention includes: a first communication unit configured to communicate with an originating side telephone; a second communication unit configured to communicate with a receiving side telephone having a display section, an input section, and a voice output section; a voice storage section storing a voice; a recording section recording an originating side voice from the originating side telephone in the voice storage section; a display control unit for controlling the display section of the receiving side telephone in accordance with recording of the originating side voice in the voice storage section; and a voice output control unit configured to control an output of the originating side voice from the voice output section in accordance with an input to the input section of the receiving side telephone.

In accordance with recording of the originating side voice the display section of the receiving side telephone is controlled, and in accordance with the input to the input section of the receiving side telephone the output of the originating side voice from the voice output section is controlled.

A recipient can check with the display section that the originating side voice is being recorded and make the originating side voice being recorded outputted by operating the input section. Since the voice can be outputted after a situation around the receiving side telephone is checked, a risk that the originating side voice is improperly heard by someone else is reduced.

(1) Here, the voice output section can include a receiver section of a handset and a speakerphone, and the originating side voice can be outputted from the handset or the speakerphone switched according to ON/OFF of a receiver hook of the receiving side telephone.

An operation of the receiver hook can make the originating side voice being outputted from the handset to enables the originating side voice not to be heard by someone else.

(2) The exchange can further include a display control table representing a correspondence between the receiving side telephone and allowing/prohibiting of a display by the display section, and based on the display control table the display control unit can control the display section.

Making recording of the originating side voice not be displayed, by a setting of the display control table enables preventing someone else from recognizing that the originating side voice is being recorded.

It is preferable that the display control table can be setted with the receiving side telephone. Inputting a personal identification information (a personal identification number and the like) prior to setting the display control table improves security.

(3) The voice output control unit can control the output of originating side voice from the voice output section on condition of an input of predetermined personal identification information from the receiving side telephone.

Allowing the output of the originating side voice on condition of the input of the personal identification information enables the originating side voice not being outputted only by someone else operating the input section.

(4) The exchange can further include: a call control unit configured to control a start of a call between the originating side telephone and the receiving side telephone in accordance with an input to the input section of the receiving side telephone.

The recipient's operating of the input section enables the call with the caller. The recipient can monitor the originating side voice and as necessary call with the caller.

(5) The display control unit can control the display section in accordance with a control state of the voice output section by the voice output control unit.

In accordance with the control state of the voice output section, the display section is controlled. According to whether merely recording the originating side voice or monitoring the originating side voice, a display state of the display section can be differentiated. For example, display contents and a display color of the display section is changed according to recording/monitoring.

### BRIEF DESCRIPTION OF THE DRAWINGS

FIG. 1 is a block diagram showing a private branch exchange related to an embodiment of the present invention.

FIG. 2 is a schematic diagram showing an example of contents of a control table.

FIG. 3 is a flowchart showing an example of an operational procedure of the private branch exchange of FIG. 1.

FIG. 4 is a chart showing an example of communication contents among an originating side telephone, a receiving side telephone, and a voicemail unit.

### DESCRIPTION OF THE EMBODIMENTS

Hereinafter, embodiments of the present invention will be described in detail with reference to the drawings.

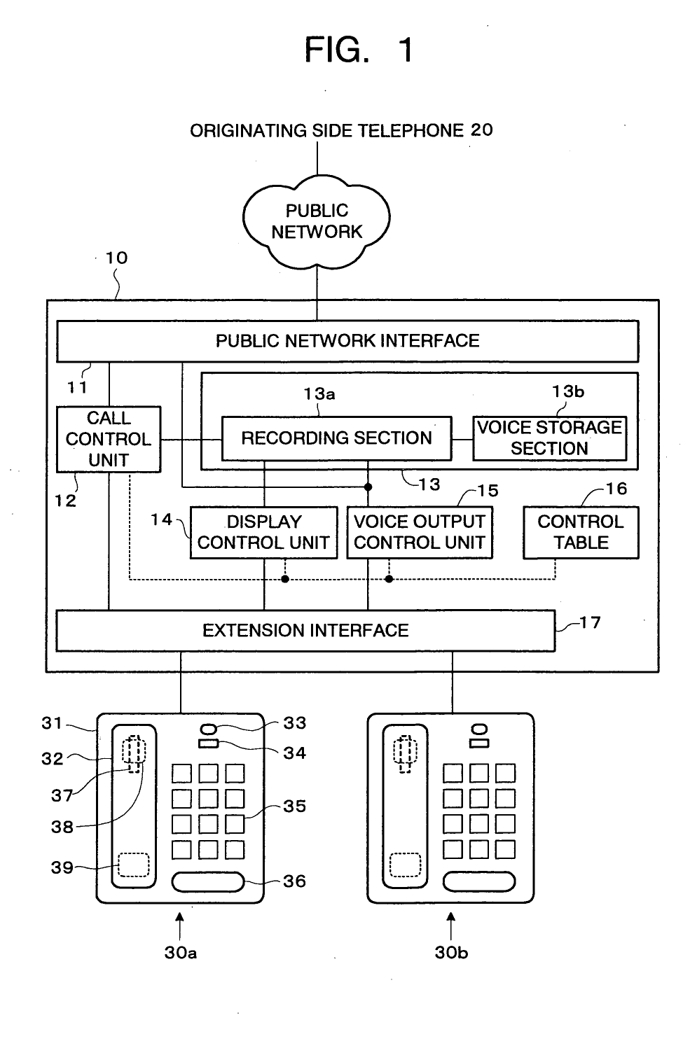

FIG. 1 is a block diagram showing a private branch exchange 10 according to an embodiment of the present invention.

The private branch exchange 10 is a telephone exchange apparatus which enables a call between an originating side telephone from a public network and a receiving side telephone 30 (30a, 30b) of a private branch.

Though in the present embodiment, for convenience in description, the telephone 20 of the public network side is a originating side and the telephone 30 of the private branch side is a receiving side, the call can be conducted when the telephone 30 of the private branch side is the originating side and the telephone 20 of the public network side is the receiving side. Also, it is possible to conduct a call between each of the telephone 30 of the private branch.

The private branch exchange 10 has a public network interface 11, a call control unit 12, a voicemail unit 13, a display control unit 14, a voice output control unit 15, a control table 16, and an extension interface 17.

The telephone 30 includes a telephone main body 31 and a handset 32. The telephone main body 31 has a monitor lamp 33, a monitor button 34, a ten-key 35, a speakerphone 36, and a receiver hook 37. The handset 32 has a receiver section 38 and a transmitter section 39.

(Details of the Private Branch Exchange 10)

The public network interface 11 is a communication unit which communicates with the originating side telephone 20 via a public network.

The call control unit 12 controls the call between the originating side telephone 20 and the receiving side telephone 30, and as necessary enables the call between the originating side telephone 20 and the voicemail unit 13 so that a voice from the originating side telephone 20 (an originating side voice) is recorded in the voicemail unit 13 (a so-called voicemail function). A user of the originating side telephone 20 (a caller) can record a message to a user of the receiving side telephone 30 (a recipient).

The voicemail unit 13 is divided into a recording section 13a and a voice storage section 13b.

The recording section 13a can record the voice from the originating side telephone 20 (the originating side voice) in the voice storage section 13b.

The voice storage section 13b is a recording device (a so-called mail box) for recording the originating side voice outputted from the recording section 13a, and can be constituted with, for example, a hard disc. This voice storage section 13b has recording areas (recording areas) divided correspondingly to each of the receiving side telephone 30. The receiving side telephone 30 can obtain a voice message addressed to that receiving side telephone 30 from the corresponding recording area.

The display control unit 14 is for controlling the monitor lamp 33 of the receiving side telephone 30, and controls the monitor lamp 33 according to whether the originating side voice is being recorded (monitorable) or the originating side voice being recorded is being monitored with the receiving side telephone 30.

The voice output control unit 15 controls an output of the originating side voice from a voice output section (the speakerphone 36 the receiver section 38) of the receiving side telephone 30 according to an operation of the monitor button 34 of the receiving side telephone 30.

The control table 16 is a table on which information for prescribing control contents of the call control unit 12, the display control unit 14, and the voice output control unit 15 is represented. Details will be described later.

The extension interface 17 is a communication unit which communicates with the receiving side telephone 30 of the private branch.

(Details of the Control Table 16)

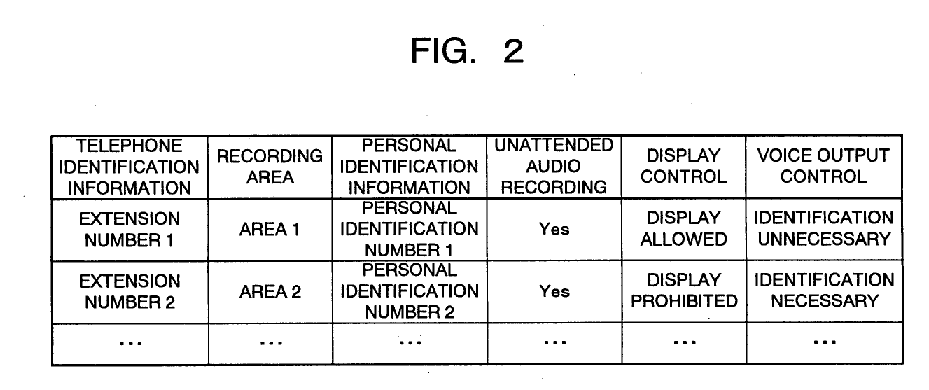

FIG. 2 is a schematic diagram showing an example of contents of the control table 16.

As shown in FIG. 2, on the control table 16, telephone identification information, recording areas, personal identification information, unattended recording, display controls, and voice output controls are indicated correspondingly.

The “telephone identification information” is the identification information for identifying each of the receiving side telephone 30, for example, an extension number.

The “recording area”, being designated correspondingly to each of the receiving side telephone 30, is information representing the recording area in the voice storage section 13b. The originating side voice addressed to the receiving side telephone 30 is recorded to an area which is represented by this recording area in the voice storage section 13b.

The “personal identification information”, being set correspondingly to each of the receiving side telephone 30, is inputted when the control table 16 is rewritten and so on. This is for ensuring security. This is also used when a message recorded in the voicemail unit 13 is listened to and, as the case may be, the originating side voice is monitored. Enabling use of a unified personal identification number provides convenience for a user. It is also possible to improve security by use of plural personal identification numbers according to purposes.

The “unattended recording” is information representing whether or not to record the originating side voice when the receiving side telephone 30 does not response during a predetermined time period. In this case, for both of the receiving side telephone 30 with the extension numbers 1 and 2, unattended recording is set.

The “display control” is information representing classification of whether to allow or prohibit a monitor display by the monitor lamp 33 such as “recording” (“monitorable”). Here, for each of the receiving side telephone 30 with the extension numbers 1 and 2, “display allowed” and “display prohibited” are set respectively. In a case of “display allowed” the monitor display by the monitor lap 33 is conducted, while in a case of “display prohibited” monitor display by the monitor lapm 33 is not conducted (even when the originating side voice is being recorded, the monitor lamp 33 is, for example, kept off).

The “display prohibited” can be released by rewriting a field of “display control” of the control table 16 from the receiving side telephone 30. As described later, for this rewriting the extension number and the personal identification number are required to be inputted.

The “voice output control” is information representing classification of whether control of an output of the originating side voice from the voice output section (the speakerphone 36, the receiver section 38) is conducted by a mere operation of the monitor button 34 or requires an input of the personal identification information. Here, for each of the receiving side telephone 30 with the extension numbers 1 and 2, “identification unnecessary” and “identification necessary” are set respectively. In the receiving side telephone 30 with the extension number 1 the originating side voice is outputted by the operation of the monitor button 34, while in the receiving side telephone 30 with the extension number 2 the output of the originating side voice requires both the operation of the monitor button 34 and the input of the personal identification number. For this personal identification number the personal identification number in a field of the “personal identification information” can be used.

The control table 16 can be partially rewritten from the receiving side telephone 30. Rewritable information are the “personal identification number”, the “unattended recording”, the “display control”, and the “voice output control” corresponding to the receiving side telephone 30. On the other hand, the “telephone identification information” and the “recording area” are, as management information for the receiving side telephone 30, unable to be rewritten by the receiving side telephone 30.

For rewriting of the control table 16 the input of the extension number and the personal identification number is required to ensure security.

(Details of the Receiving Side Telephone 30)

Next, details of the receiving side telephone 30 will be described.

The monitor lamp 33 functions by being controlled by the display control unit 14 as a display device (a display section) which represents a handling state of the originating side voice (for example, “recording” (“monitorable”), “monitoring”).

The monitor lamp 33 can be structured for example o an LED so that a displayed color represents the handling state of the originating side voice. For example, “recording” can be represented by red, “monitoring” can be represented by green, and a state neither of them can be represented by non-lightedness.

The monitor button 34 functions as an input device (an input section) for inputting an output instruction information to make the voice output control unit 15 output, from the voice output section (the speakerphone 36, the receiver section 38) of the receiving side telephone 30, the originating side voice which is being recorded, or a call start instruction information to instruct the call control unit 12 to start the call with the originating side telephone 20.

The monitor button 34 can be constituted with plural buttons (or keys) corresponding to respective inputs of the output instruction information and the call start instruction information. It is possible to classify these information according to a number of button inputs. For example, it is possible to define that the output instruction information should be inputted by a first button input and the call start instruction information should be inputted by a second (repeated) button input. In the present embodiment, the latter is employed so that a single monitor button 34 can instruct both of the voice output and the call start, simplifying an input mechanism.

When the single monitor button 34 instructions both of the voice output and the call start, it is preferable that the private branch exchange 10 has a storage section which stores the number of button inputs or a state of the output control (“recording”, “monitoring”). The voice output control unit 15 compares stored contents of this storage section with the operation of the monitor button 34 so that an accurate control of the voice output of the originating side voice can be conducted easily.

Such a storage section can be also provided in the receiving side telephone 30. Additionally, instead of an electronic method a mechanical method can be used. It is possible to apply various methods which enable perceiving a correspondence between the operation of the monitor button 34 and contents of the instruction (the output instruction, the call start instruction).

The ten-key 35 can be used for inputting a telephone number of the other party and the personal identification number. The ten-key 35 can be used, at a time of rewriting the control table 16, for inputting an item to be rewritten and for instructing contents thereof.

The speakerphone 36 is a voice output device which enables listening to a voice with the handset 32 being placed on the telephone main body 31.

The receiver hook 37 is an input device for recognizing whether the handset 32 is placed on the telephone main body 31 or not (whether it is picked up by a user). When the handset 32 is placed on the telephone main body 31, the receiver hook 37 is pressed to be in “ON” state. When the handset 32 is for example picked up by the user and not placed on a predetermined position of the telephone main body 31, the receiver hook 37 is in “OFF” state. The ON/OFF of the receiver hook 37 is transmitted to the private branch exchange 10 as a sort of input information so that starting/ending of the call and later described switching/ending of the originating side voice are conducted.

The receiver section 38 and the transmitting section 39 are, respectively, devices for outputting and inputting the voice.

(Operation of the Private Branch Exchange 10)

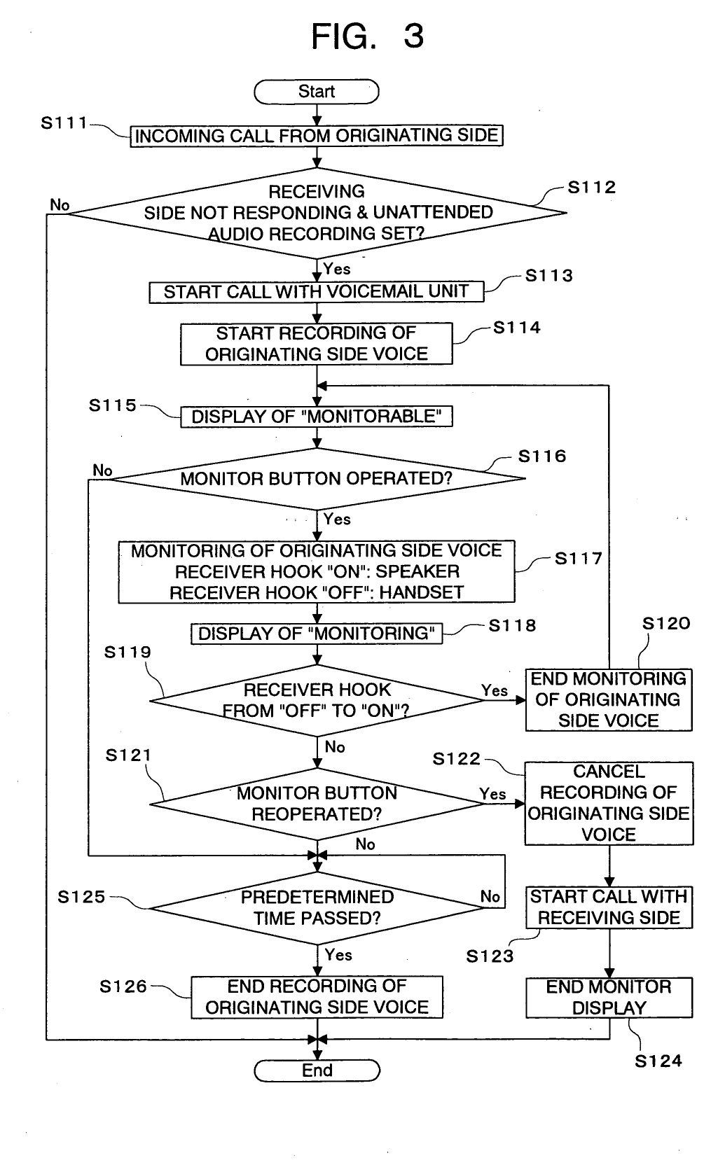

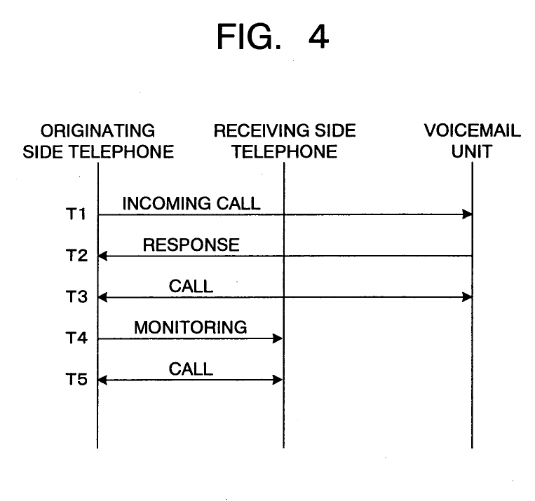

FIG. 3 is a flowchart showing an example of an operational procedure of the private branch exchange 10 when a call arrives from the originating side telephone 20 to a receiving side telephone 30a. FIG. 4 is a chart showing an example of communication contents at this time among the originating side telephone 20, the receiving side telephone 30a, and the voicemail unit 13.

Hereinafter, the operation of the private branch exchange 10 will be described based on FIG. 3 and FIG. 4.

(1) Via the public network an incoming call from the originating side telephone 20 to the receiving side telephone 30a is received by the private branch exchange 10 (step S111 in FIG. 3).

The call control unit 12, in accordance with the incoming call, rings the receiving side telephone 30a. If there is no response from the receiving side telephone 30a (the “ON” state of the receiver hook 37 continues) during the predetermined time period (or predetermined number of ringings) and on the control table 16 the “unattended recording” is set to be “YES” (step S112), the originating side telephone 20 is connected to the voicemail unit 13 and becomes in a calling state (step S113 in FIG. 3).

This call is started by a terminating call from the originating side telephone 20 being transferred to the voicemail unit 13 (step T1 in FIG. 4) and in answer to the transferred terminating call the voicemail unit 13 transmitting a response signal (generally close a loop) to the call control unit 12 (steps T2 and T3 in FIG. 4).

In accordance with this staring of the call, the call control unit 12 transmits information in the “recording area” of the control table 16 (a code (VM-ID) designating the recording area (the mail box) in the voice storage section 13b) to the voicemail unit 13.

(2) Recording of the voice from the originating side telephone 20 (originating side voice) is started (step S114 in FIG. 3).

Prior to this recording, the voicemail unit 13 sends, as necessary, the originating side telephone 20 a voice message (which has been preliminarily stored in the voice storage section 13b) to prompt to tell a message. The voice the caller utters at the originating telephone side according to this message is stored in the voice storage section 13b in the voicemail unit 13.

(3) Virtually simultaneously of this recording of the originating side voice, the voicemail unit 13 makes the display control unit 14 instruct the monitor lamp 33 to conduct a display that the originating side voice is being recorded (step S115 in FIG. 3).

This display also means “monitorable”, i.e. the originating side voice being recorded can be monitored. If the monitor lamp 33 is an LED this display can be represented by a blinking and the like thereof. For example a red blinking of the LED can represent “monitorable”.

When a field of the “display control” of the control table 33 is set to be “display prohibited”, the monitor lamp 33 does not conduct the display of the monitoring state. It becomes unknown that the originating side voice is being recorded.

(4) The operation of the monitor button 34 makes the originating side voice being recorded outputted from the voice output section (the speakerphone 36, the receiver section 38) of the receiving side telephone 30a (steps S116 and S117 in FIG. 3 and step T4 in FIG. 4). The recording of the originating side voice is continued

This voice is outputted by the voice output control unit 15 transmitting the originating side voice to the receiving side telephone 30a according to the operation of the monitor button 34.

If a field o the “voice output control” is set to be “identification necessary”, in order for monitoring the originating side voice an input of the personal identification number with the ten-key 35 and the like becomes necessary in addition to the operation of the monitor button 34. The originating side voice is prevented from being monitored by someone else, and security is ensured.

An output destination of the originating side voice can be switched according to “ON” and “OFF” of the receiver hook 37. When the monitor button 34 is operated in a state that the handset 32 is placed on the telephone main body 31, the originating side voice can be monitored with the speakerphone 36. When the monitor button 34 is operated in a state that the handset 32 is picked up, the originating side voice can be monitored with the handset 32 (receiver section 38).

When the handset 32 is picked up during monitoring with the speakerphone 36, monitoring can be continued with the handset 32. When someone else approaches during monitoring with the speakerphone 36, switching to monitoring with the handset 32 enables protecting privacy of monitored contents.

This switching of the output can be conducted by the voice output control unit 15 designating the output device (the speaker phone 36, the handset 32) to the receiving side telephone 30. Switching can be also conducted in the receiving side telephone 30 by ON/OFF of the receiver hook 37 being set to link the output device.

(5) In accordance with the output of the originating side voice from the voice output section, the monitor lamp 33 is changed to a display representing “monitoring” (step S118 in FIG. 3). if the monitor lamp 33 is an LED, for example, it changes from the red blinking representing “recording” (“monitorable”) to the green blinking.

(6) If during this monitoring a call-ending operation such as placing the handset 32 (the receiver hook 37 becomes “ON” from “OFF”) is conducted, monitoring of the originating side voice with the receiving side telephone 30a is ended (steps S119 and S120 in FIG. 3). The monitor lamp 33 is changed to a display representing “monitorable” (step S115 in FIG. 3).

Even when monitoring is ended, recording of the originating side voice is continued.

(7) If during monitoring the monitor button 34 is reoperated, the monitoring state is released (step S121 to step S124 in FIG. 3).

Recording of the originating side voice is cancelled (step S122 in FIG. 3), and a call between the receiving side telephone 30a and the originating side telephone 20 is started (step S123 in FIG. 3, step T5 in FIG. 4). Then, the display by the monitor lamp 33 becomes for example in a state that the monitor display is ended (for example non-lighting of the LED)(step S124 in FIG. 3).

(8) Recording of the originating side voice is ended after a predetermined time (steps S125 and S126 in FIG. 3).

Thereafter by an operation from the receiving side telephone 30a, a recorded originating side voice can be listened to from the voicemail unit 13. Since the input of the extension number and the personal identification number is necessary for this, security is ensured.

As described above, use of the private branch exchange 10 according to the present embodiment offers following advantages, especially for ensuring security.

(1) Since a predetermined operation is required in order for monitoring (listening to) the originating side voice being recorded, the message being recorded can be prevented from being improperly heard by someone else near the receiving side telephone 30.

(2) If someone else approaches during monitoring (listening to) the originating side voice being recorded with the speakerphone 36, by picking up the handset 32 monitoring can be switched to the handset 32. The message being recorded can be prevented from being improperly heard.

(3) By requiring the input of the personal identification number as a condition for monitoring, the contents being recorded can be prevented from being freely listened to by someone else.

(Other Embodiments)

The present invention is not limited to the above-described embodiment, and expansion and change thereof may be made. The expanded and changed embodiments are also included in the technical range of the present invention.

In the above embodiment, the case of dealing with the transmission from the public network is described, but the present invention can be applied to other cases such as a call between extension telephones of the private branch.

1. An exchange comprising:
a first communication unit configured to communicate with an originating side telephone;
a second communication unit configured to communicate with a receiving side telephone having a display section, an input section, and a voice output section;
a voice storage section storing a voice;
a recording section recording an originating side voice from the originating side telephone in said voice storage section;
a display control unit configured to control the display section of the receiving side telephone in accordance with recording of the originating side voice in said voice storage section; and
a voice output control unit configured to control an output of the originating side voice from the voice output section in accordance with an input to the input section of the receiving side telephone.

2. The exchange as set forth in claim 1,
wherein the voice output section includes a receiver section of a handset and a speakerphone, and
the originating side voice is outputted from the handset or the speakerphone switched according to ON/OFF of a receiver hook of the receiving side telephone.

3. The exchange as set forth in claim 1,
further comprising: a display control table showing a correspondence between the receiving side telephone and allowing/prohibiting of a display by the display section, and
wherein, based on said display control table, said display control unit controls the display section.

4. The exchange as set forth in claim 1,
wherein said voice output control unit controls an output of the originating side voice from the voice output section, on condition of an input of predetermined personal identification information from the receiving side telephone.

5. The exchange as set forth in claim 1,
further comprising: a call control unit configured to control a start of the call between the originating side telephone and the receiving side telephone in accordance with an input to the input section of the receiving side telephone.

6. The exchange as set forth in claim 1,
wherein said display control unit controls the display section in accordance with a control state of the voice output section by said voice output control unit.

7. A communication method, comprising:
recording an originating side voice from an originating side telephone in a voice storage section;
controlling a display section of a receiving side telephone in accordance with recording of the originating side voice in the voice storage section; and
controlling an output of the originating side voice from a voice output section of the receiving side telephone in accordance with an input to an input section of the receiving side telephone.

8. The communication method as set forth in claim 7,
wherein the voice output section includes a receiver section of a handset and a speakerphone, and
further comprising: switching an output of the originating side voice between the handset and the speakerphone according to ON/OFF of a receiver hook of the receiving side telephone.

9. The communication method as set forth in claim 7,
wherein controlling the output from the voice output section includes controlling the display section based on a display control table representing a correspondence between the receiving side telephone and allowing/prohibiting of a display by the display section.

10. The communication method as set forth in claim 7, wherein controlling the output from the voice output section includes controlling the output of the originating side voice from the voice output section on condition of an input of predetermined personal identification information from the receiving side telephone.

11. The communication method as set forth in claim 7, further comprising: controlling a start of a call between the originating side telephone and the receiving side telephone, in accordance with an input to an input section of the receiving side telephone.

12. The communication method as set forth in claim 7, further comprising: controlling the display section in accordance with a control state of the output from the voice output section.
